(19) United States
(12) Patent Application Publication
(10) Pub. No.: US 2019/0225021 A1
(43) Pub. Date: Jul. 25, 2019

(54) TIRE WITH LAMINATE

(71) Applicant: Bridgestone Americas Tire Operations, LLC, Nashville, TN (US)

(72) Inventors: Pablo M. Rojas, Franklin, TN (US); Nihar N. Raje, Uniontown, OH (US); Aleksandr I. Shmagranoff, Akron, OH (US)

(73) Assignee: Bridgestone Americas Tire Operations, LLC, Nashville, TN (US)

(21) Appl. No.: 16/316,887

(22) PCT Filed: Jul. 12, 2017
(86) PCT No.: PCT/US17/41717

§ 371 Date: Jan. 10, 2019

Related U.S. Application Data
(60) Provisional application No. 62/361,555, filed on Jul. 13, 2016.

(51) Int. Cl. B60C 11/00; B60C 11/04; B60C 9/28; B60C 9/20

(52) U.S. Cl. CPC B60C 11/005; B60C 11/04; B60C 2200/06; B60C 9/2006; B60C 9/28

(57) ABSTRACT

A lamella, membrane, or overlay for use in a tire is provided. A lamella, membrane, or overlay is a thin layer of material (distinct from a subtread, tread base, or undercushion), disposed above reinforcing belts, that primarily extends circumferentially and axially. The lamella, membrane, or overlay reduces strain fields within the tire, reduces internal temperatures within the tire, enhances rolling resistance, and improves tire durability. The lamella, membrane, or overlay may be used in various tire applications, including without limitation, truck-and-bus-radial (TBR), heavy-duty, and passenger/light truck (PLTD) tire applications.

### FIELD OF INVENTION

The present disclosure is directed to tires having multiple reinforcing belts which include a laminate, lamella, or overlay that reduces internal temperatures within the tire, enhances rolling resistance, and improves tire durability. More particularly, the present disclosure is directed to tires having a laminate, lamella, or overlay disposed above multiple reinforcing belts. The tire embodiments of the present disclosure may be used in various tire applications, including without limitation, truck-and-bus-radial (TBR), heavy-duty, and passenger/light truck (PLTD) tire applications.

### BACKGROUND

Known tires include belts for reinforcement and structural purposes. The belts, in conjunction with other tire components, affect tire performance. Exemplary performance attributes include tire stiffness, rolling resistance, and durability.

### SUMMARY OF THE INVENTION

In one embodiment, a tire comprises a first annular bead and a second annular bead, a body ply extending between the first annular bead and the second annular bead, a belt package, disposed radially above the body ply. The belt package comprises a first annular belt, a second annular belt, and a third annular belt, all of which extend axially across a portion of the body ply. The tire also comprises a circumferential tread, disposed radially above the third annular belt, comprising a tread cap, tread base, and undercushion, all of which extend axially across a portion of the body ply, a first sidewall extending between the first annular bead and a first shoulder, the first shoulder being associated with the circumferential tread, a second sidewall extending between the second annular bead and a second shoulder, the second shoulder being associated with the circumferential tread. The tire further comprises an annular lamella disposed radially between the third annular belt and the tread base, and extending axially across at least 50% of the tread width, wherein the lamella has a tan δ of 0.04-0.09.

In a second embodiment, a tire comprises a tire scaffold, wherein the tire scaffold comprises a base ply, a pair of annular beads, a pair of sidewalls, at least three reinforcing belts, and a rubber casing, a tire tread, affixed to, and disposed radially upward of, the tire scaffold, wherein the tire tread includes at least two main circumferential grooves, at least three circumferential ribs, and a tread base, and a low-rolling-resistance laminate, disposed radially between the reinforcing belts and the tread base.

In a third embodiment, a tire comprises a first annular bead and a second annular bead, a body ply extending between the first annular bead and the second annular bead, a first reinforcing belt, disposed radially above the body ply and extending axially across a portion of the body ply, a second reinforcing belt disposed radially above the first reinforcing belt and extending axially across a portion of the body ply, and a circumferential tread, disposed radially above the reinforcing belts. The circumferential tread comprises a tread cap, tread base, and undercushion, all of which extend axially across a portion of the body ply. The tire also comprises a first sidewall extending between the first annular bead and a first shoulder, the first shoulder being associated with the circumferential tread, and a second sidewall extending between the second annular bead and a second shoulder, the second shoulder being associated with the circumferential tread. The tire further comprises an overlay disposed radially above the reinforcing belts, and extending axially across at least 20% of a tire section width.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a peel-away cross-sectional perspective view of an embodiment of a tire including a laminate;

FIG. 2a is a close-up cross-sectional view of the tire depicted in FIG. 1;

FIG. 2b is a close-up cross-sectional view of an alternative embodiment of a tire having a laminate;

FIG. 3a is a peel-away cross-sectional perspective view of one embodiment of a tire including a laminate;

FIG. 3b is a peel-away cross-sectional perspective view of an alternative embodiment of a tire including a laminate;

FIG. 4a is a close-up cross-sectional view of another alternative embodiment of a tire including a laminate;

FIG. 4b is a close-up cross-sectional view of yet another alternative embodiment of a tire including a laminate; and

FIG. 5 is a peel-away cross-sectional perspective view of an embodiment of a tire including a laminate.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Radial” and “radially” refer to a direction perpendicular to the axis of rotation of a tire.

“Sidewall” as used herein, refers to that portion of the tire between the tread and the bead.

“Tire scaffold” as used herein, refers to both (1) a green tire and (2) a retread tire casing or carcass.

“Tread” as used herein, refers to that portion of the tire that comes into contact with the road or ground under normal inflation and normal load.

“Tread depth” refers to the distance between a top surface of the tread and the bottom of a major tread groove.

“Tread width” refers to the width of the ground contact area of a tread which contacts with the road surface during the rotation of the tire under normal inflation and load.

While similar terms used in the following descriptions describe common tire components, it is understood that because the terms carry slightly different connotations, one of ordinary skill in the art would not consider any one of the following terms to be purely interchangeable with another term used to describe a common tire component. Furthermore, to the extent the term “under” is used in the specification or claims, it is intended to mean not only “directly under” but also “indirectly under” where intermediary tire layers or components are disposed between two identified components or layers.

Directions are stated herein with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” or “top” and “bottom” are used in connection with an element, the “upper” or “top” element is spaced closer to the tread than the “lower” or “bottom” element. Additionally, when relative directional terms such as “above” or “below” are used in connection with an element, an element that is “above” another element is closer to the tread than the other element.

The terms “inward” and “inwardly” refer to a general direction towards the equatorial plane of the tire, whereas “outward” and “outwardly” refer to a general direction away from the equatorial plane of the tire and towards the sidewall of the tire. Thus, when relative directional terms such as “inner” and “outer” are used in connection with an element, the “inner” element is spaced closer to the equatorial plane of the tire than the “outer” element.

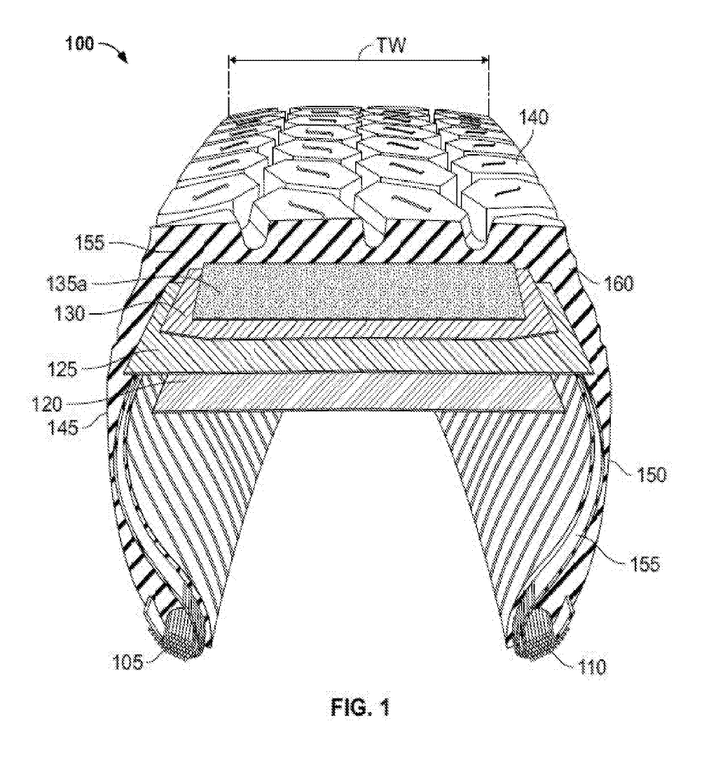

FIG. 1 is a peel-away cross-sectional perspective view of an embodiment of a tire 100 including a laminate. As shown, tire 100 includes a first annular bead 105 and a second annular bead 110. The annular beads, in part, secure the tire to a wheel. In an alternative embodiment (not shown), the tire comprises four or more beads.

As shown, tire 100 further includes a body ply 115 extending between first annular bead 105 and second annular bead 110. Body ply 115 forms an annulus and imparts shape to the tire. As one of ordinary skill in the art will understand, body ply 115 may contain reinforcing cords (not labeled) or fabric (not shown). In alternative embodiments (not shown), various turn-up and turn-down configurations, or multiple body plies, are used.

Tire 100 further includes a belt package which comprises a first annular belt 120, a second annular belt 125, and a third annular belt 130. First annular belt 120 is disposed radially upward of body ply 115 and extends axially across a portion of body ply 115. Second annular belt 125 is disposed radially upward of first annular belt 120 and extends axially across a portion of body ply 115. Third annular belt 130 is disposed radially upward of second annular belt 125 and extends axially across a portion of body ply 115. Thus, as shown in FIG. 1, tire 100 comprises exactly three belts. As one of ordinary skill in the art will understand, the annular belts may contain steel cords and reinforcing cords (both not shown), and the belt package may further include one or more additional reinforcing plies and cap plies (both also not shown). In an alternative embodiment (not shown), the belt package further comprises a fourth annular belt (thus, in the embodiment shown in FIG. 1, the belt package lacks a fourth annular belt).

Tire 100 includes an annular laminate 135a. As shown, laminate 135a is disposed radially between third annular belt 130 and a circumferential tread 140. Laminate 135a has a generally consistent thickness (although one skilled in the art will appreciate that variable thicknesses exist).

Further, as shown, laminate 135a extends axially across a portion of body ply 115. In a first embodiment, the laminate extends axially across 45-110% of the tread width. In a second embodiment, the laminate extends axially across at least 80-110% of the tread width. In a third embodiment, the laminate has an axial width that is 45-80% of a tread width. In particular tire embodiments having three annular belts, the laminate may be disposed radially above the third annular belt. In differing tire embodiments—e.g., in known tire designs having four annular belts—the laminate may replace the fourth annular belt.

Although not shown, in one embodiment, the laminate is formed from an elastomer. When the tire is cured (or re-cured), the laminate forms a non-viscous, vulcanized polymer. Thus, the laminate is not a self-sealing or self-repairing layer. Furthermore, the laminate is not formed from a thermoplastic layer, it is not an adhesive, tackifier, or cement, and it is not specifically configured to conduct electric charge. The laminate does not contain nylon or fabric, and it is not a cap ply.

In one embodiment, the laminate is formed from an elastomer having a tan δ of 0.04-0.09. In an alternative embodiment, the laminate is formed from an elastomer having a tan δ of 0.05-0.08. In another alternative embodiment, the laminate is formed from an elastomer having a tan δ of 0.065-0.075. In a particular embodiment, the laminate has a uniform stiffness and is formed from a homogeneous elastomer (although one skilled in the art will appreciate that alternatives exist). Tan δ is determined according to the testing methods described in ASTM D5992-96 (Reapproved 2011) (“Standard Guide for Dynamic Testing of Vulcanized Rubber and Rubber-Like Materials Using Vibratory Methods”). More specifically, tan δ is determined according to one of (1) a forced vibration of a non-resonant system involving only the specimen, (2) free vibration of a resonant system the specimen and a mass, or (3) forced vibration of a resonant system the specimen and a mass, as further described in ASTM D5992-96 (Reapproved 2011). Regardless of which testing method is used, tan δ is determined by changing strain conditions from 0-5% at 25° C. and identifying the largest value under these conditions.

Furthermore, the laminate reduces strain fields within the tire. In particular, the laminate reduces strains associated with loading and unloading the tire, as the tire moves through its footprint. Accordingly, the laminate reduces internal temperatures within the tire, enhances rolling resistance, and improves tire durability.

Tire 100 further comprises a circumferential tread 140. Circumferential tread 140 is disposed radially upward of third annular belt 130 (and the belt package) and extends axially across a portion of body ply 115. Circumferential tread 140 has a width, the tread width, which is denoted as TW. As depicted, three zigzag circumferential grooves divide circumferential tread 140 into four ribs. As one of ordinary skill in the art will understand, a circumferential tread may contain additional elements such as, without limitation, sacrificial ribs, sipes, stone ejectors, and tie bars. As one of ordinary skill in the art will also understand, the circumferential tread is affixed to the tire (e.g., by vulcanization) when the tire is new. In an alternative embodiment (not shown), the circumferential tread is affixed as a retread.

Tire 100 further comprises a first sidewall 145 and a second sidewall 150. First sidewall 145 extends between the first annular bead 105 and a first shoulder 155, which is proximately associated with an edge of circumferential tread 140. Second sidewall 150 extends between the second annular bead 110 and a second shoulder 160, which is proximately associated with an opposite edge of circumferential tread 140. In alternative embodiments (not shown), the sidewall includes one or more sidewall protector(s), electronic device(s), and/or cooling fin(s).

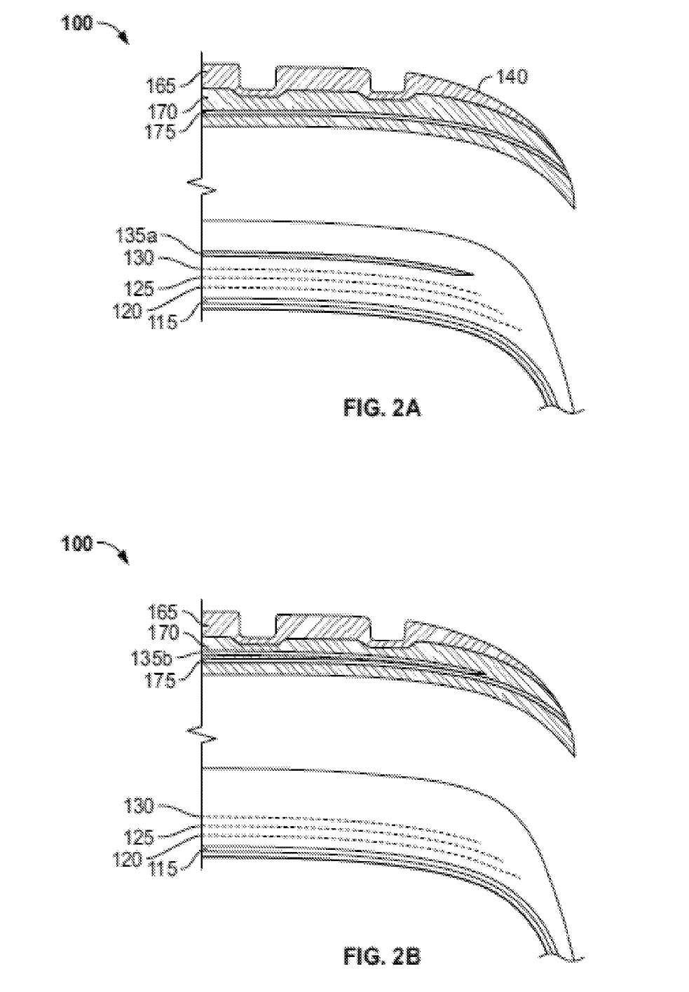

FIG. 2a is a close-up cross-sectional view of the right half of tire 100. Like elements from FIG. 1 have been identified with the same reference numerals.

In addition to FIG. 1, FIG. 2a further shows circumferential tread 140 as comprising a tread cap 165, a tread base 170, and an undercushion 175. Tread cap 165, tread base 170, and undercushion 175 all extend axially across a portion of body ply 115.

Tread cap 165 is disposed radially upward with respect to tread base 170. Tread cap 165 is the first tread layer that is worn as the tire is used. It may be formulated to possess particular performance attributes that are desirable when the tire is new. Tread base 170 is the second tread layer that is worn as the tire is used. It may be formulated to possess particular performance attributes that are desirable when the tire is worn. In one example, the first tread layer is formulated to maximize rolling resistance and the second tread layer is formulated to maximize wet traction. As one of ordinary skill in the art will understand, the tread cap and tread base can be co-extruded. In an alternative embodiment (not shown), the tread cap and tread base are a unitary layer formed from a single material.

Tread base 170 is disposed radially between tread cap 150 and undercushion 175. Undercushion 175 provides a thin layer of material that enhances ride comfort and absorbs vibration and strain in the tire. As one of ordinary skill in the art will understand, a laminate and an undercushion have different physical and dynamic mechanical properties. For example, a laminate will typically have a lower tan δ and is less stiff in comparison to an undercushion. Further, the laminate will typically have less carbon black content and will utilize a different type of carbon black.

As shown in FIG. 2a, undercushion 175 is disposed radially between tread base 170 and laminate 135a. As one of ordinary skill in the art will understand, the additional rubber that surrounds laminate 135a, such as the rubber that would be present in a green tire, a partially cured tire, or a previously cured tire is not explicitly labeled. Thus, as shown in FIG. 2a, laminate 135a and undercushion 175 do not directly contact each other. In an alternative embodiment (not shown), the laminate directly contacts a portion of the undercushion. In another alternative embodiment (also not shown), the tread cap and tread base are combined in one layer.

Although not explicitly shown in FIG. 2a, laminate 135a has a radial height (i.e., a thickness) between 75% and 125% of the radial height of the third annular belt. In a specific embodiment (not shown), the laminate has a radial height between 90% and 110% of the third annular belt. In one embodiment, the laminate has a thickness between 0.5 and 10.0 mm. In a specific embodiment, the laminate has a thickness between 1.0 and 3.0 mm. In another specific embodiment, the laminate has a thickness between1.5 and 2.5 mm.

FIG. 2b is a close-up cross-sectional view of an alternative embodiment of the tire embodiment depicted in FIG. 2a. The FIG. 2b embodiment is substantially the same as the FIG. 2a embodiment, except for the differences discussed below. In this embodiment, laminate 135b is disposed radially between tread base 170 and undercushion 175. Thus, as depicted in FIG. 2b, laminate 135b is disposed in circumferential tread 140. In an alternative embodiment (not shown), the laminate is disposed radially upward of the undercushion, the laminate directly contacts the undercushion. The laminate and undercushion may be provided separately from the circumferential tread.

In a particular embodiment (not shown), tire 100 has a section width between 215 and 450 mm, an aspect ratio between 50 and 90, and a radius between 15 and 29 inches.

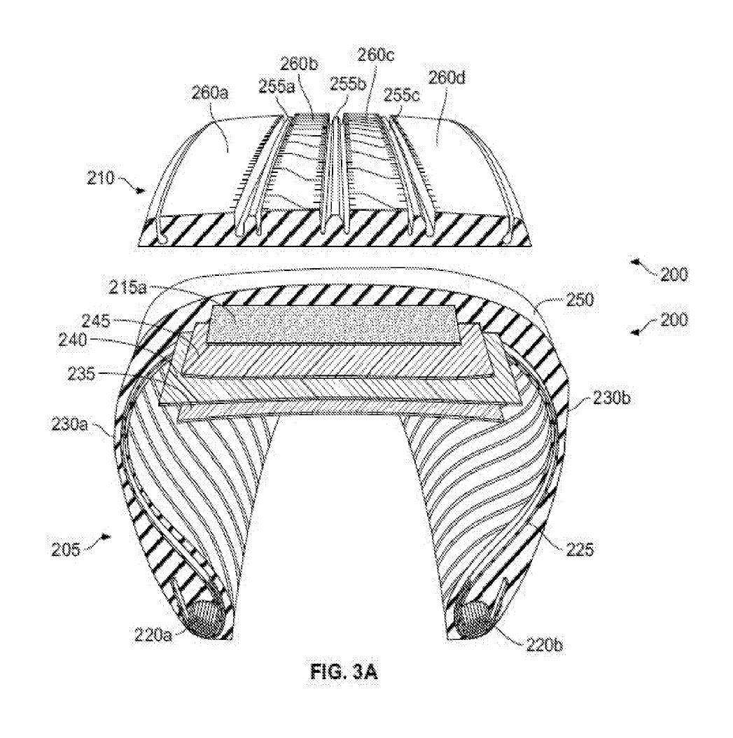

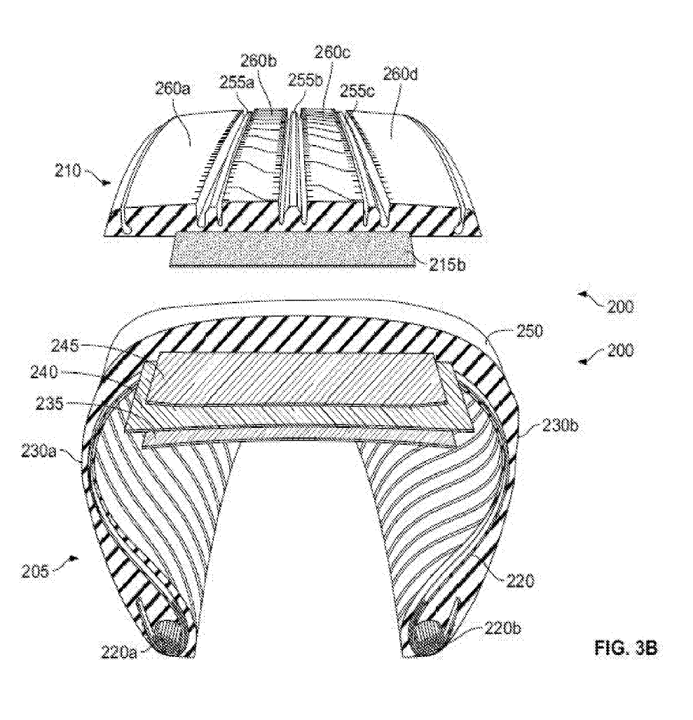

FIG. 3a is a peel-away cross-sectional perspective view of one embodiment of a tire 200 including a laminate. As shown, tire 200 comprises a tire scaffold 205, a tire tread 210, and a low-rolling-resistance laminate 215a.

Tire scaffold 205 can be a green tire (such as would be used in new-tire manufacturing), or it can be a casing or carcass (such as would be used in retread applications). As shown, tire scaffold 205 comprises a pair of annular beads 220a and 220b, a base ply 225, and a pair of sidewalls 230a and 230b. The annular beads 220a and 220b, base ply 225, and sidewalls 230a and 230b are substantially similar to the annular beads 105 and 110, body ply 115, and sidewalls 165 and 170 described with relation to FIG. 1.

Tire scaffold 205 further comprises a first reinforcing belt 235, a second reinforcing belt 240, and a third reinforcing belt 245. Thus, as shown, tire scaffold 205 contains at least three reinforcing belts. In a particular embodiment, the tire scaffold contains exactly three belts. In a different embodiment, the tire scaffold contains exactly four belts. As one of ordinary skill in the art will understand, the reinforcing belts may contain metal (e.g., steel) or synthetic cords. In an alternative embodiment (not shown), the tire scaffold further includes at least one cap ply.

A rubber casing 250 envelopes the components comprising tire scaffold 205. In embodiments directed toward new manufacturing applications, rubber casing 250 begins as green rubber and may be partially or fully vulcanized. In embodiments directed toward retread applications, rubber casing 250 begins as cured rubber. The rubber casing may be buffed and repaired during the retreading process.

With continued reference to FIG. 3a and tire 200, tire 200 further includes a tire tread 210. As shown, tire tread 210 includes circumferential grooves 255a, 255b, and 255c that divide the tire tread 210 into circumferential ribs 260a, 260b, 260c, and 260d. In an alternative embodiment (not shown), the tire tread includes at least two main circumferential grooves and at least three circumferential ribs. In another alternative embodiment, the tire tread includes four circumferential grooves and at least five circumferential ribs. As one of ordinary skill in the art will understand, the tire tread may have a variety of grooves and sipes.

With continued reference to FIG. 3a and tire 200, tire 200 further includes a laminate 215a. As shown, laminate 215a is disposed between the reinforcing belts and tire tread 210. In particular, laminate 215a is depicted as being disposed in tire scaffold 205. Although not shown, the laminate may be provided in a variety of ways. In one embodiment, the laminate is provided by wrapping it around the tire scaffold or a surface of a tire component (e.g., without limitation, a belt or tire tread). In another embodiment, the laminate is provided by placing it on the tire scaffold or a tire component. Friction and pressure and/or an adhesive, tackifier, or cement may be used to affix the laminate to the tire scaffold or a tire component. In yet another embodiment, the laminate is coextruded with a tire component.

In embodiments directed toward new manufacturing applications, a layer (not shown) of adhesive, tackifier, or cement may be provided on either a green tire tread or green tire scaffold for adhering the green tire tread and green tire scaffold together. In embodiments directed toward retread applications, a layer (not shown) of adhesive, tackifier, or cement may be provided on either a retread or tire scaffold for adhering the retread and tire scaffold together. Additional retread processing further secures the retread to the tire scaffold. In embodiments directed to new manufacturing or retread applications, the laminate is not an adhesive, tackifier, or cement. Likewise, in embodiments directed to new manufacturing or retread applications, the laminate is not a tread antenna.

FIG. 3b is a peel-away cross-sectional perspective view of an alternative embodiment of the tire depicted in FIG. 3a. In comparison to tire embodiment shown in FIG. 3a, in the embodiment shown in FIG. 3b, laminate 215b is disposed on the underside of tire tread 210. Thus, in retread embodiments, the laminate can be sold with the retread—i.e., separately from the casing.

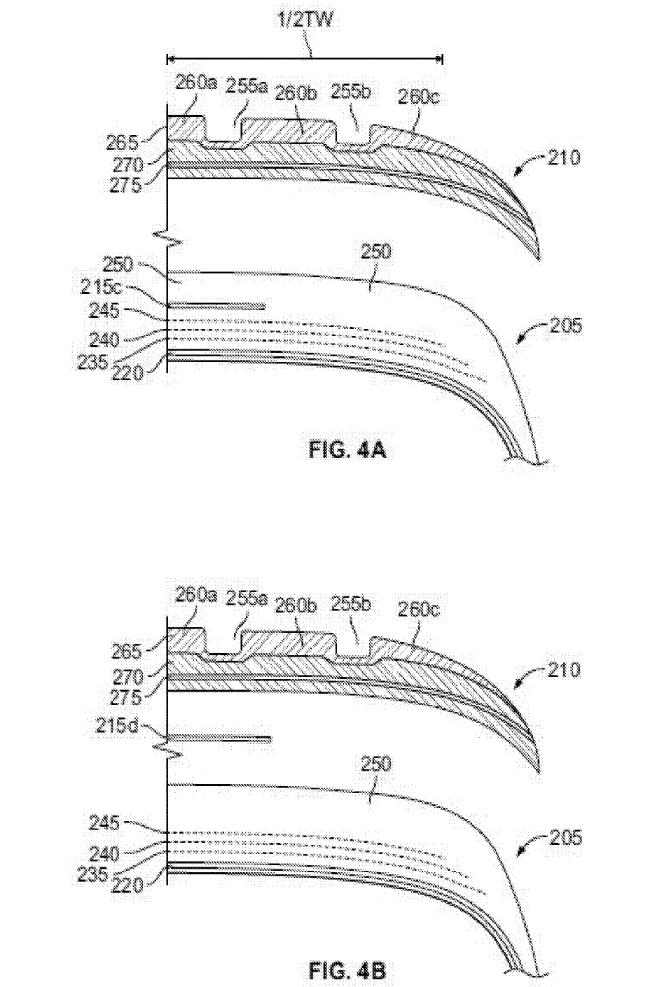

FIG. 4a is a close-up cross-sectional view of an alternative embodiment of the tire 200, which is depicted in FIG. 3a.

In addition to FIG. 3a, FIG. 4a further shows tire tread 210 as comprising a tread cap 265, a tread base 270, and an undercushion 275. Tread cap 265 is disposed radially upward with respect to tread base 270. Tread base 270 is disposed radially between tread cap 265 and undercushion 275. Tread cap 265, tread base 270, and undercushion 275 all extend axially across a portion of base ply 225. The tread cap 265, tread base 270, and undercushion 275 are substantially similar to the tread cap 165, tread base 170, and undercushion 175 described with relation to FIG. 1.

FIG. 4a also shows laminate 215c disposed within tire scaffold 205 and enveloped by rubber casing 250. In an alternative embodiment (not shown), the laminate is partially enveloped by the rubber casing. In particular tire embodiments having three reinforcing belts, the laminate may be disposed radially above the third reinforcing belt. In differing tire embodiments—e.g., in known tire designs having four reinforcing belts—the laminate may replace the fourth reinforcing belt.

In the embodiment shown in FIG. 4a, laminate 215c extends axially over a portion of the third reinforcing belt 245. In particular, in FIG. 4a, laminate 215c is depicted as extending over 30% of one half of the tread width (½ TW). In one alternative embodiment (not shown), the laminate has an axial width that spans at least two main circumferential grooves (as measured from the lowest point of the groove). In another alternative embodiment, the laminate has an axial width 20-45% of the tread width and crosses the tire equator (the axial center of the tire). In yet another embodiment, the laminate has an axial width 20-45% of the section width and crosses the tire equator (the axial center of the tire). In a different alternative embodiment, the laminate has an axial width between 70 and 220 mm.

FIG. 4b is a close-up cross-sectional view of an alternative embodiment of the tire embodiment depicted in FIG. 4a. In comparison to tire embodiment shown in FIG. 4a, in the embodiment shown in FIG. 4b, laminate 215d is disposed on the underside of tire tread 210. Thus, in tire 200, laminate 215d is also disposed radially between the reinforcing belts and the tread base.

In a particular embodiment (not shown), tire 200 has a section width between 215 and 450 mm, an aspect ratio between 50 and 90, and a radius between 15 and 29 inches.

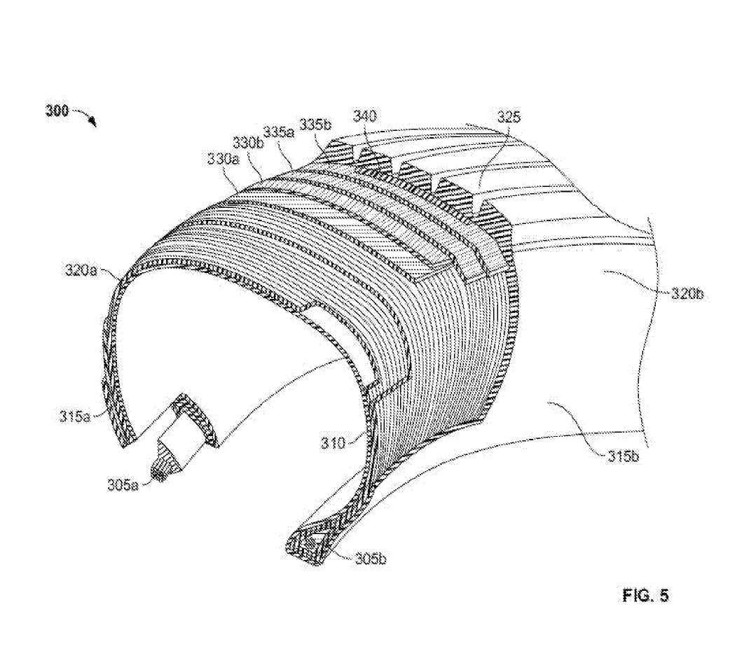

FIG. 5 is a peel-away cross-sectional perspective view of an embodiment of a tire 300 including a laminate. As one of ordinary skill in the art will understand, FIG. 5 depicts a passenger/light truck (PLTD) tire.

As shown, tire 300 includes a first annular bead 305a, a second annular bead 305b, a body ply 310, a first sidewall 315a, a second sidewall 315b, a first shoulder 320a, a second shoulder 320b, and a circumferential tread 325. While these components are similar to the beads, body ply, sidewalls, shoulders, and treads described above, one of ordinary skill in the art will appreciate that the components shown in FIG. 5 are configured for passenger/light truck applications. In alternative embodiments (not shown), the components are configured for non-PLTD tire applications. Suitable exemplary non-PLTD tire applications include, without limitation, agricultural tires, tires used on construction vehicles, and tires used in mining applications.

Circumferential tread 325 is disposed radially above the reinforcing belts 330a and 330b. Although not explicitly shown, one skilled in the art will understand that the circumferential tread may further comprise a tread cap, tread base, and undercushion, all of which extend axially across a portion of the body ply. In an alternative embodiment (also not shown), the circumferential tread consists of two layers (e.g., without limitation, a tread cap and a tread base). In yet another alternative embodiment, the circumferential tread consists of exactly one layer.

With continued reference to FIG. 5, tire 300 includes a first reinforcing belt 330a and a second reinforcing belt 330b. First reinforcing belt 330a is disposed radially above body ply 310 and extends axially across a portion of body ply 310. Second reinforcing 330b belt is disposed radially above the first reinforcing belt 330a and extends axially across a portion of the body ply 310. In an alternative embodiment (not shown), the tire further comprises a third reinforcing belt that is disposed radially above the second reinforcing belt and extends axially across a portion of the body ply.

Tire 300 further includes cap plies 335a and 335b. First cap ply 335a is disposed radially upward of reinforcing belts 330a and 330b and extends axially across a portion of body ply 310. Second cap ply 335b is disposed radially upward of first cap ply 335a and extends axially across a portion of body ply 310.

Tire 300 also includes a laminate 340. As shown, the laminate 340 is a thin layer of material that primarily extends circumferentially and axially. In FIG. 5, laminate 340 extends axially across at least 20% of the tire's section width. Additionally, laminate 340 is disposed axially over the middle third of a tread width. In an alternative embodiment (not shown), the laminate extends across at least 40% of the tire's section width.

As shown, laminate 340 is disposed radially upward of the cap plies 335a and 335b. In an alternative embodiment (not shown), the laminate is disposed radially below the cap plies. In another alternative embodiment, the laminate is disposed radially between the cap plies.

FIG. 5, laminate 340 extends axially across 20-50% of the tire's section width. Additionally, laminate 340 is disposed axially over the middle third of a tread width. In an alternative embodiment (not shown), the laminate extends across at least 40-80% of the tire's section width.

As one of ordinary skill in the art will understand, the tire embodiments of the present disclosure may be used in truck-and-bus-radial (TBR), retread, heavy-duty, and PLTD tire applications.

Without limitation, exemplary TBR and heavy-duty tire sizes include tires having a section width between 215 and 460 mm, an aspect ratio between 50 and 90, and a radius between 15 and 29 inches. Specific exemplary section widths include 295, 315, 425, and 445 mm; specific exemplary aspect ratios include 60, 65, 75, 80, 85, and 90; and specific exemplary radiuses include 22, 22.5, 24, and 25 inches.

Without limitation, exemplary PLTD tire sizes include tires having a section width between 200 and 270 mm, an aspect ratio between 30 and 85, and a radius between 15 and 24 inches. Specific exemplary section widths include 215, 235, and 265 mm; specific exemplary aspect ratios include 50, 65, 75, 80, and 85; and specific exemplary radiuses include 16, 17, and 18 inches.

While the disclosure uses the term laminate, alternative terms may also be used to describe the invention without departing from the spirit or scope of the applicant's general inventive concept. Three such alternative terms include, without limitation, lamella, membrane, and overlay.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative apparatus and method, and illustrative examples shown and described. Accordingly, departures may be made from such details without departing from the spirit or scope of the applicant's general inventive concept.

What is claimed is:

1-15. (canceled)

16. A tire comprising:
a first annular bead and a second annular bead;
a body ply extending between the first annular bead and the second annular bead;
a belt package, disposed radially above the body ply, comprising a first annular belt, a second annular belt, and a third annular belt, all of which extend axially across a portion of the body ply;
a circumferential tread, disposed radially above the third annular belt, comprising a tread cap, tread base, and undercushion, all of which extend axially across a portion of the body ply;
a first sidewall extending between the first annular bead and a first shoulder, the first shoulder being associated with the circumferential tread;
a second sidewall extending between the second annular bead and a second shoulder, the second shoulder being associated with the circumferential tread; and
an annular lamella disposed radially between the third annular belt and the tread base, and extending axially across at least 50% of the tread width, wherein the lamella has a tan δ of 0.04-0.09.

17. The tire of claim 16, wherein the belt package lacks a fourth annular belt.

18. The tire of claim 16, wherein the lamella is disposed radially between the third annular belt and the undercushion.

19. The tire of claim 16, wherein the lamella is a nonviscous, vulcanized polymer.

20. The tire of claim 16, wherein the lamella has a thickness between 75% and 125% of the third annular belt.

21. The tire of claim 16, wherein the lamella has a thickness between 1.0 and 3.0 mm.

22. The tire of claim 16, wherein the lamella has an axial width that is between 50 and 80% of a tread width.

23. A tire comprising:
a tire scaffold, wherein the tire scaffold comprises a base ply, a pair of annular beads, a pair of sidewalls, at least three reinforcing belts, and a rubber casing;
a tire tread, affixed to, and disposed radially upward of, the tire scaffold, wherein the tire tread includes at least two main circumferential grooves, at least three circumferential ribs, and a tread base; and
a low-rolling-resistance laminate, disposed radially between the reinforcing belts and the tread base.

24. The tire of claim 23, wherein the tire comprises exactly three reinforcing belts.

25. The tire of claim 23, wherein the laminate is disposed radially between the rubber casing and the tread base.

26. The tire of claim 23, wherein the laminate is affixed to the tire tread.

27. The tire of claim 23, wherein the tire has a section width between 280 and 460 mm.

28. The tire of claim 23, wherein the laminate has an axial width that spans at least two main circumferential grooves.

29. The tire of claim 23, wherein the laminate has an axial width between 75 and 225 mm.

30. The tire of claim 23, wherein the laminate has a tan δ 0.05-0.08.

31. A method of making a tire comprising:
providing a first annular bead and a second annular bead;
extending a body ply between the first annular bead and the second annular bead;
placing a first reinforcing belt radially above the body ply and axially across a portion of the body ply;
placing a second reinforcing belt radially above the first reinforcing belt and axially across a portion of the body ply;
placing a circumferential tread radially above the reinforcing belts, wherein the circumferential tread includes a tread cap, tread base, and undercushion;
extending a first sidewall between the first annular bead and a first shoulder, the first shoulder being associated with the circumferential tread;
extending a second sidewall between the second annular bead and a second shoulder, the second shoulder being associated with the circumferential tread; and
placing an overlay radially above the reinforcing belts and axially across at least 20% of a tire section width.

32. The method of claim 31, wherein the overlay has a uniform stiffness.

33. The method of claim 31, wherein the overlay has a tan δ of 0.04-0.09.

34. The method of claim 31, wherein the placing of the overlay includes placing the overlay axially over the middle third of a tread width.

35. The method of claim 31, further comprising placing a third reinforcing belt radially above the second reinforcing belt ply and axially across a portion of the body ply.
